(19) United States
(12) Patent Application Publication
(10) Pub. No.: US 2018/0104960 A1
(43) Pub. Date: Apr. 19, 2018

(54) INK MEASURING SYSTEM AND PRINTING DEVICE

(71) Applicant: BOE TECHNOLOGY GROUP CO.,LTD., Beijing (CN)

(72) Inventor: Dejiang ZHAO, Beijing (CN)

(21) Appl. No.: 15/557,245

(22) PCT Filed: Jan. 3, 2017
(86) PCT No.: PCT/CN2017/000036

§ 371 Date: Sep. 11, 2017

(30) Foreign Application Priority Data
May 11, 2016 (CN) 201610311363.6

(51) Int. Cl. B41J 2/195; B41J 2/17

(52) U.S. Cl. CPC B41J 2/195; B41J 2/1714

(57) ABSTRACT

An ink measuring system and a printing device including the ink measuring system. The ink measuring system includes: a measuring cavity body provided with an opening, where the measuring cavity body includes a side wall and a bottom, and the bottom and the opening are oppositely disposed; at least an air exhaust pipeline penetrating through the bottom; and a filter core disposed inside the measuring cavity body. The printing device further includes a printing system having a bubble discharging function. The printing system includes: a liquid storage box; a sprayer; a liquid inlet pipeline connected to the liquid storage box and the sprayer; a bubble detecting device disposed outside a bubble detecting point of the liquid inlet pipeline; a sprayer valve disposed in the liquid inlet pipeline; a bubble discharging pipeline connected with the liquid inlet pipeline; and a bubble discharging valve disposed in the bubble discharging pipeline.

### TECHNICAL FIELD

Embodiments of the present disclosure relate to an ink measuring system and a printing device.

### BACKGROUND

An ink-jet printer is developed after a stylus printer, and it adopts a non-beating working manner and has characteristics of a small size, simplicity and convenience in operation, low printing noise and the like.

In recent years, the ink-jet printer technology has made great progress. The ink-jet printing technology can be used to manufacture an Organic Light-Emitting Diode (OLED) and other products and has the characteristics of rapidness, a simple manufacture process, low cost and the like, and its ink is made of a photoelectric material and a solvent, etc.

### SUMMARY

Embodiment of the disclose provide an ink measuring system, comprising: a measuring cavity body provided with an opening, where the measuring cavity body includes a side wall and a bottom, and the bottom and the opening are oppositely disposed; at least an air exhaust pipeline penetrating through the bottom; and a filter core disposed inside the measuring cavity body.

For example, in the ink measuring system provided by an embodiment of the disclosure, the filter core includes a honeycomb structure.

For example, in the ink measuring system provided by an embodiment of the disclosure, the honeycomb structure is of a multilayered honeycomb structure.

For example, in the ink measuring system provided by an embodiment of the disclosure, the honeycomb structure includes a plurality of honeycomb holes, and apertures of at least part of the honeycomb holes are smaller than 3 microns.

For example, the ink measuring system provided by an embodiment of the disclosure further comprises an air exhaust device, wherein the air exhaust device is disposed outside the measuring cavity body and is connected to the air exhaust pipeline.

For example, the ink measuring system provided by an embodiment of the disclosure further comprises a transparent structure, wherein the transparent structure is disposed on the side wall along the opening.

For example, the ink measuring system provided by an embodiment of the disclosure further comprises a measuring device, wherein the measuring device is disposed outside the transparent structure.

For example, in the ink measuring system provided by an embodiment of the disclosure, the side wall and the bottom are hermetically sealed.

For example, the ink measuring system provided by an embodiment of the disclosure further comprises at least a cleaning pipeline, wherein the cleaning pipeline penetrates through the side wall of the measuring cavity body.

For example, in the ink measuring system provided by an embodiment of the disclosure, the cleaning pipeline is disposed between the filter core and the opening.

For example, the ink measuring system provided by an embodiment of the disclosure further comprises a cleaning device, wherein the cleaning device is disposed outside the measuring cavity body and is connected to the cleaning pipeline.

Embodiments of the disclosure further provide a printing device, comprising the ink measuring system described above.

For example, the printing device provided by an embodiment of the disclosure further comprises an ink recycling device, wherein the ink recycling device includes a recycling cavity body provided with a recycling hole.

For example, in the printing device provided by an embodiment of the disclosure, the ink recycling device further includes an ink recycling pipeline, and the ink recycling pipeline penetrates through the recycling cavity body.

For example, the printing device provided by an embodiment of the disclosure further comprises a printing system having a bubble discharging function, wherein the printing system includes: a liquid storage box; a sprayer; a liquid inlet pipeline connected to the liquid storage box and the sprayer; a bubble detecting device disposed outside a bubble detecting point of the liquid inlet pipeline; a sprayer valve disposed in the liquid inlet pipeline, wherein the sprayer valve is located between the bubble detecting point and the sprayer; a bubble discharging pipeline connected with the liquid inlet pipeline, wherein a connection point between the bubble discharging pipeline and the liquid inlet pipeline is located between the bubble detecting point and the sprayer valve; and a bubble discharging valve disposed in the bubble discharging pipeline.

For example, in the printing device provided by an embodiment of the disclosure, the printing system further includes an ink recycling box, an air path pipeline and a recycling pipeline, the bubble discharging pipeline is connected with the ink recycling box, a first end of the air path pipeline is connected with the ink recycling box, a first end of the recycling pipeline is connected with the ink recycling box, and a second end of the recycling pipeline is connected with the liquid storage box.

For example, in the printing device provided by an embodiment of the disclosure, in the ink recycling box, a position of the first end of the recycling pipeline is lower than a position of the first end of the air path pipeline.

For example, in the printing device provided by an embodiment of the disclosure, the printing system further includes an temporary ink storage device, a liquid inlet valve and a bubble pre-discharging pipeline, the liquid inlet valve is disposed in the liquid inlet pipeline and located between the bubble detecting point and the liquid storage box, a first end of the bubble pre-discharging pipeline is connected with the liquid inlet pipeline via the liquid inlet valve, and a second end of the bubble pre-discharging pipeline is connected with the temporary ink storage device.

For example, in the printing device provided by an embodiment of the disclosure, the liquid inlet pipeline includes a first liquid inlet sub-pipeline and a second liquid inlet sub-pipeline, the first liquid inlet sub-pipeline is located between the liquid storage box and the liquid inlet valve, and the second liquid inlet sub-pipeline is located between the liquid inlet valve and the sprayer; the liquid inlet valve is a multidirectional solenoid valve and is configured to connect the first end of the bubble pre-discharging pipeline to the first liquid inlet sub-pipeline or connect the first end of the bubble pre-discharging pipeline to the second liquid inlet sub-pipeline.

For example, in the printing device provided by an embodiment of the disclosure, the printing system further includes a temporary storage valve, and the temporary storage valve is disposed in the bubble pre-discharging pipeline.

For example, in the printing device provided by an embodiment of the disclosure, the printing system further includes an temporary ink storage device, a first temporary storage valve and a second temporary storage valve, the temporary ink storage device is disposed in the liquid inlet pipeline and located between the bubble detecting point and the liquid storage box, the first temporary storage valve is disposed in the liquid inlet pipeline and located between the temporary ink storage device and the liquid storage box, and the second temporary storage valve is disposed in the liquid inlet pipeline and located between the temporary ink storage device and the bubble detecting point.

For example, in the printing device provided by an embodiment of the disclosure, the printing system further includes a sprayer connector, and the sprayer connector is disposed in the liquid inlet pipeline between the bubble detecting point and the liquid storage box.

For example, in the printing device provided by an embodiment of the disclosure, the bubble detecting device includes a sound wave bubble detecting device.

### BRIEF DESCRIPTION OF THE DRAWINGS

In order to illustrate the technical solutions in the embodiments of the present disclosure more clearly, the drawings need to be used in the description of the embodiments will be briefly described in the following; it is obvious that the drawings described below are only related to some embodiments of the present disclosure, and not intended to be limitative to the disclosure.

FIG. 1 is a schematic diagram of an ink measuring system;

FIG. 2A is a first schematic diagram of an ink measuring system provided by an embodiment of the present disclosure;

FIG. 2B is a second schematic diagram of an ink measuring system provided by an embodiment of the present disclosure;

FIG. 3 is a first partial schematic diagram of an ink measuring system provided by an embodiment of the present disclosure;

FIG. 4 is a second partial schematic diagram of an ink measuring system provided by an embodiment of the present disclosure;

FIG. 5 is a schematic diagram of an ink recycling device provided by an embodiment of the present disclosure;

FIG. 6 is a first schematic diagram of a printing system having a bubble discharging function provided by an embodiment of the present disclosure;

FIG. 7 is a second schematic diagram of a printing system having a bubble discharging function provided by an embodiment of the present disclosure;

FIG. 8 is a third schematic diagram of a printing system having a bubble discharging function provided by an embodiment of the present disclosure;

FIG. 9 is a fourth schematic diagram of a printing system having a bubble discharging function provided by an embodiment of the present disclosure;

FIG. 10 is a schematic diagram of a bubble detecting device in a printing system having a bubble discharging function provided by an embodiment of the present disclosure; and

FIG. 11 is a composition block diagram of a printing device provided by an embodiment of the present disclosure.

### DETAILED DESCRIPTION

Hereafter, the technical solutions of the embodiments of the present disclosure will be described in a clearly and fully understandable way. With reference to the drawings that are described in details below, example and non-limitative embodiments and their various features and beneficial details are described in a more complete way. It is noted that features shown in the drawings are not shown with actual scales. Known materials, components and manufacture technologies are omitted in the disclosure, so as not to obscure the example embodiments of the disclosure. Examples provided herein only aim to be helpful for understanding implementation of the example embodiments of the disclosure, and further helpful for one skilled in the art to be able to implement the example embodiments. Thus, the examples should not be understood as limitation on scope of embodiments of the disclosure.

Unless otherwise clearly defined and limited, technical terms or scientific terms used in the disclosure should have ordinary meanings understood by persons having ordinary skills in the field of the disclosure. Terms such as “first,” “second,” or similar terms in the disclosure are not intended to represent any order, quantities or importance, but are used to distinguish different composing parts. In addition, in each embodiment of the disclosure, identical or similar reference numbers represent identical or similar elements.

An OLED product manufactured by the ink-jet printing technology has characteristics of rapidness and low cost and the like, while factors such as a stable production process, an accurate measurement of volumes of ink drops and pollution prevention are all related to a product quality.

The ink-jet printing technology is to precisely print ink drops into each designed pixel through a printing sprayer; in this way, a volume and a falling point of each ink drop are required to be accurate, and if the ink drops have different volumes, then the thicknesses of printed thin films are different and the product quality is affected.

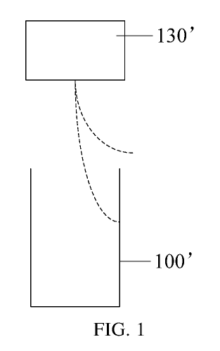

For example, FIG. 1 is a schematic diagram of an ink measuring system 100′. As shown in FIG. 1, in order for accurate measurement, in a process that the ink drops are sprayed out of a sprayer 130′, the ink drops are needed to fall down in a straight line; but in fact, a path where the ink drops fall down is often bent, which affects normal measurement, and affects measurement accuracy.

An ink measuring system provided by an embodiment of the present discourse can improve a measurement precision of the ink drops, and further improve the precision of a printing device; and meanwhile, splash of the ink drops is prevented and further device pollution is reduced.

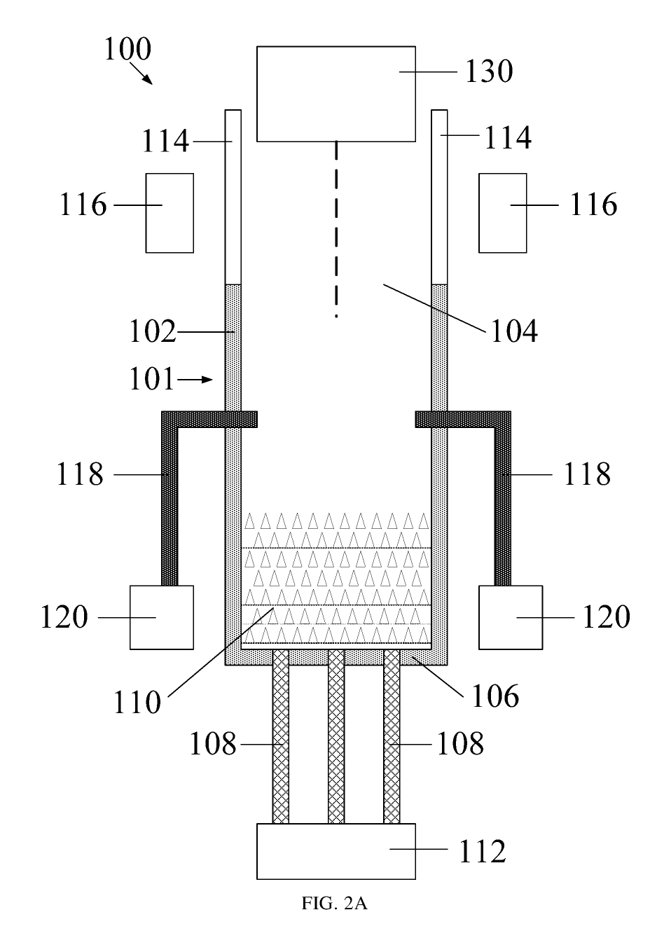

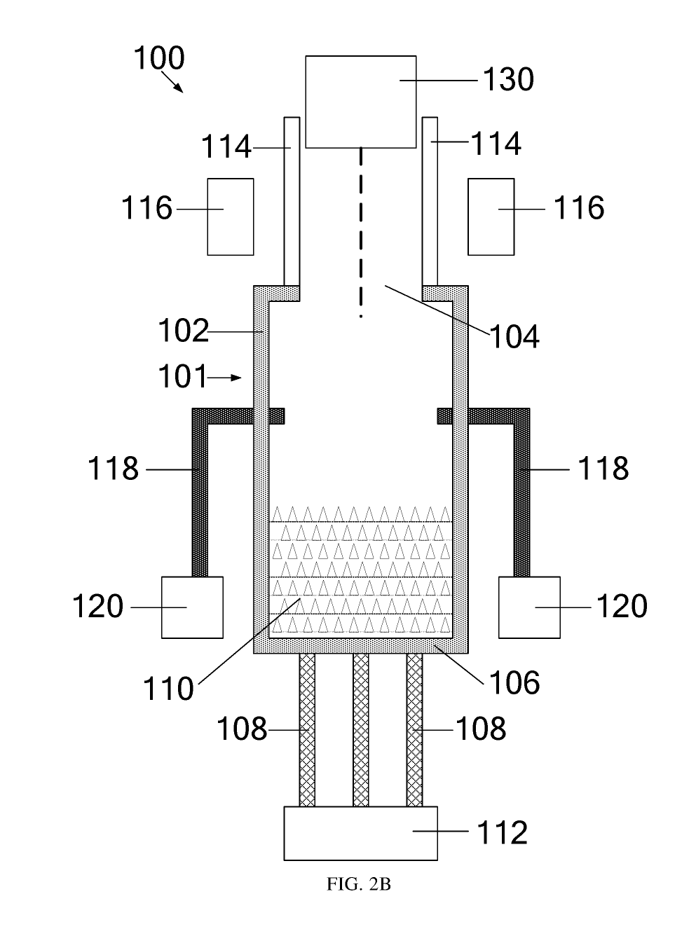

For example, FIG. 2A is a first schematic diagram of an ink measuring system provided by an embodiment of the present disclosure; and FIG. 2B is a second schematic diagram of an ink measuring system provided by an embodiment of the present disclosure. As shown in FIG. 2A and FIG. 2B, the ink measuring system 100 provided by embodiments of the present disclosure comprises: a measuring cavity body 101 provided with an opening 104, where the measuring cavity body 101 includes a side wall 102 and a bottom 106, with the bottom 106 and the opening 104 being oppositely disposed; at least one air exhaust pipeline 108 penetrating through the bottom 106; and a filter core 110 disposed inside the measuring cavity body 101.

For example, the top of the measuring cavity body 101 is provided with an opening 104, and a shape of the opening 104 includes one of a round shape, a rectangle and a regular polygon, or a combination thereof. The opening 104 can also be in other shapes and is not limited in the present disclosure. For example, the size of the opening 104 (for example, a diameter of the round opening, a length of a short side of the rectangular opening and an incircle diameter of the regular polygonal opening) is larger than that of the sprayer 130 (for example, a maximal outer diameter of the sprayer 130), such that the sprayer 130 can enter the measuring cavity body 101 from the opening 104 to prevent ink from leaking out and polluting the device.

For example, the side wall 102 of the measuring cavity body 101 is of a tube structure, and a cross section of the tube structure includes one of a round shape, a rectangle and a regular polygon, or a combination thereof. For example, the measuring cavity body 101 can be a cylindrical, cuboid or cube cavity body.

For example, the measuring cavity body 101 includes a bottom 106 opposite to the opening 104, that is, the bottom 106 is disposed on one side of the measuring cavity body 101 away from the opening 104. For example, in the ink measuring system 100 provided by an embodiment of the present disclosure, the side wall 102 and the bottom 106 are hermetically sealed together to prevent the ink drops from being leaked out. For example, the bottom 106 can be adhered to a bottom side of the side wall 102. Or, the bottom 106 and the side wall 102 can be of an integral structure. For example, when the ink measuring system 100 normally operates, the bottom 106 is closer to the Earth's core than the opening 104 on the top, such that the ink sprayed out from the sprayer 130 moves from the opening 104 on the top to the bottom 106 under action of gravity.

For example, as shown in FIG. 2A and FIG. 2B, the ink measuring system 100 comprises three air exhaust pipelines 108, which all penetrate through the bottom 106, such that an air path in each air exhaust pipeline 108 (for example, a ventilating path) is connected with an inner cavity of the measuring cavity body 101 respectively. It is noted that the quantity of the air exhaust pipelines includes, but not limited to, the scenario as shown in FIG. 2A and FIG. 2B, and can be selected according to actual needs. For example, at least one through hole can be manufactured in the bottom 106 of the measuring cavity body 101, then air exhaust pipelines 108 having a same quantity as the through holes are fixed on the bottom 106 in a manner of welding or threaded connection and the like, and each air exhaust pipeline 108 penetrates through the bottom 106 via one through hole.

For example, the air exhaust pipelines 108 and the bottom 106 of the measuring cavity body 101 can be integrally formed in a manner of mold processing and the like. For example, an outer wall of each air exhaust pipeline 108 is hermetically sealed with the bottom 106 of the measuring cavity body 101, and air leakage or ink drop leakage is prevented.

For example, in the ink measuring system 100 provided by an embodiment of the present disclosure, the filter core 110 includes a honeycomb structure. The filter core 110 with the honeycomb structure can play roles of balancing airflows and preventing deflecting of the ink drops, so that a measurement precision is improved. For example, the honeycomb structure can be a multilayered honeycomb structure. The filter core 110 with the multilayered honeycomb structure can further balance the airflows and prevent deflecting of the ink drops. For example, the honeycomb structure includes a plurality of honeycomb holes, and apertures of at least part of the honeycomb holes are smaller than 3 microns. The honeycomb holes each with an aperture being smaller than 3 microns can better balance the airflows and smash the ink drops, so as to conveniently discharge the ink drops. It is noted that in the ink measuring system 100 provided by embodiments of the present disclosure, the structure of the filter core 110 includes, but not limited to, the honeycomb structure, and can also include other structures that can balance the airflows or disperse the ink drops.

For example, the ink measuring system 100 provided by an embodiment of the present disclosure further comprises an air exhaust device 112, and the air exhaust device 112 is disposed outside the measuring cavity body 101 and is connected to the air exhaust pipelines 108. For example, the air exhaust device 112 can exhaust air in the interior of the measuring cavity body 101 through the air exhaust pipelines 108. Then, negative pressure is formed in the measuring cavity body 101, and further airflows flowing from the opening 104 (or the sprayer 130) to the bottom 106 are formed, which causes the ink drops to move together with the airflows, so that a falling path of the ink drops is prevented from being deflected, and a measurement precision is improved. For example, the air exhaust device 112 is an exhaust fan. For another example, an air exhaust device 112 can also be disposed inside each air exhaust pipeline 108.

For example, the ink measuring system 100 provided by an embodiment of the present disclosure further comprises a transparent structure 114. The transparent structure 114 is disposed on the side wall 102 along the opening 104. For example, the transparent structure 114 is disposed on the top edge of the side wall 102.

For example, the transparent structure 114 can be a tube structure, and a cross section of the tube structure includes one or a combination of a round shape, a rectangle and a regular polygon. In some examples, the transparent structure 114 and the side wall 102 can have an identical shape. The transparent structure 114 and the side wall 102 can be connected in a manner of adhering, threaded connection or riveting, etc. The transparent structure 114 can be a transparent wind wall or transparent wind baffle. The transparent structure 114 can play a role of wind shielding so that falling paths of the ink drops are prevented from being deflected.

For example, the ink measuring system 100 provided by an embodiment of the present disclosure further comprises a measuring device 116 which is disposed outside the transparent structure 114. For example, the measuring device 116 includes a photoelectric measuring device which can measure data such as a volume and velocity of an ink drop. For example, the measuring device 116 includes an optical lens, a sensor and an image processing module. Image information of the ink drops is obtained by the optical lens and the sensor, and then the image processing module processes the image information to obtain parameters such as the volumes and velocities of the ink drops. For example, the measuring device 116 is located in a position corresponding to the transparent structure 114 and outside the transparent structure 114, that is to say, the measuring device 116 can measure the data of the ink drops though the transparent structure 114.

For example, the ink measuring system 100 provided by an embodiment of the present disclosure further comprises at least one cleaning pipeline 118, which penetrates through the side wall 102 of the measuring cavity body 101. The ink measuring system 100 further comprises a cleaning device 120, which is disposed outside the measuring cavity body 101 and connected to the cleaning pipeline 118. For example, cleaning fluid is stored in the cleaning device 120, and the cleaning device 120 feeds the cleaning fluid into the measuring cavity body 101 through the cleaning pipeline 118 so as to clean the filter core 110 and the air exhaust pipelines 108. For example, as shown in FIG. 2A and FIG. 2B, the ink measuring system 100 comprises two cleaning pipelines 118. It is noted that the number of the cleaning pipelines 118 includes, but not limited to, the scenarios as shown in FIG. 2A and FIG. 2B, and the cleaning pipelines 118 can be flexibly configured according to actual needs.

For example, in the ink measuring system 100 provided by an embodiment of the present disclosure, the cleaning pipelines 118 can be disposed between the filter core 110 and the opening 104. That is to say, a position of a fluid outlet for the cleaning fluid in the cleaning pipeline 118 is between the filter core 110 and the opening 104, such that the cleaning fluid enters the filter core 110 and the cleaning pipeline 108 under the action of gravity or airflows so as to perform a cleaning function.

For example, the cleaning device 120 periodically sprays the cleaning fluid into the measuring cavity body 101 by the cleaning pipelines 118. For example, the cleaning device 120 sprays the cleaning fluid into the measuring cavity body 101 in every other certain time period.

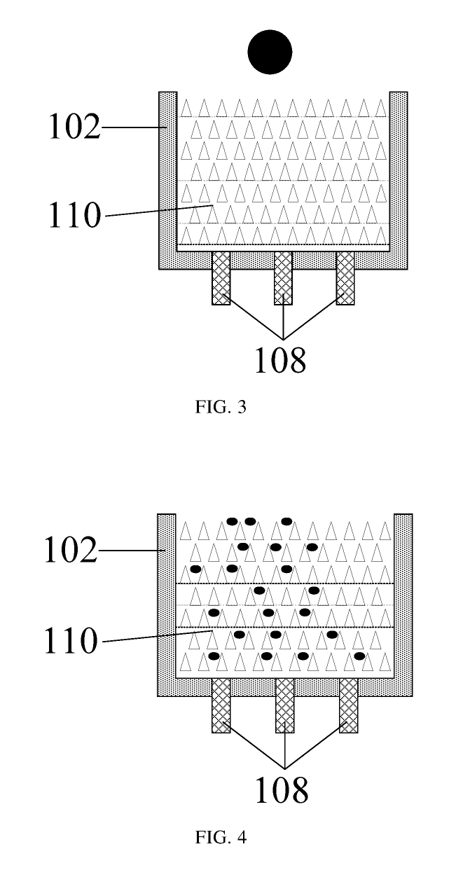

For example, FIG. 3 is a first partial schematic diagram of an ink measuring system provided by an embodiment of the present disclosure; and FIG. 4 is a second partial schematic diagram of part of the ink measuring system provided by an embodiment of the present disclosure. As shown in FIG. 3 and FIG. 4, the air exhaust device 112 exhausts air through the air exhaust pipelines 108, and the filter core 110 enables the airflows to be uniformly distributed. When an ink drop falls onto the filter core 110, the ink drop may be smashed into a plurality of small ink drops on the filter core 110. The plurality of small ink drops are exhausted from the air exhaust pipelines 108 by the exhaust device 112 after passing by the filter core 110.

For example, the air exhaust device 112, the air exhaust pipelines 108 and the filter core 110 combined together can produce balanced airflows, such that balanced airflows are achieved in the measuring cavity body 101, and falling paths of the ink drops are prevented from being deflected, and further the measurement precision is improved.

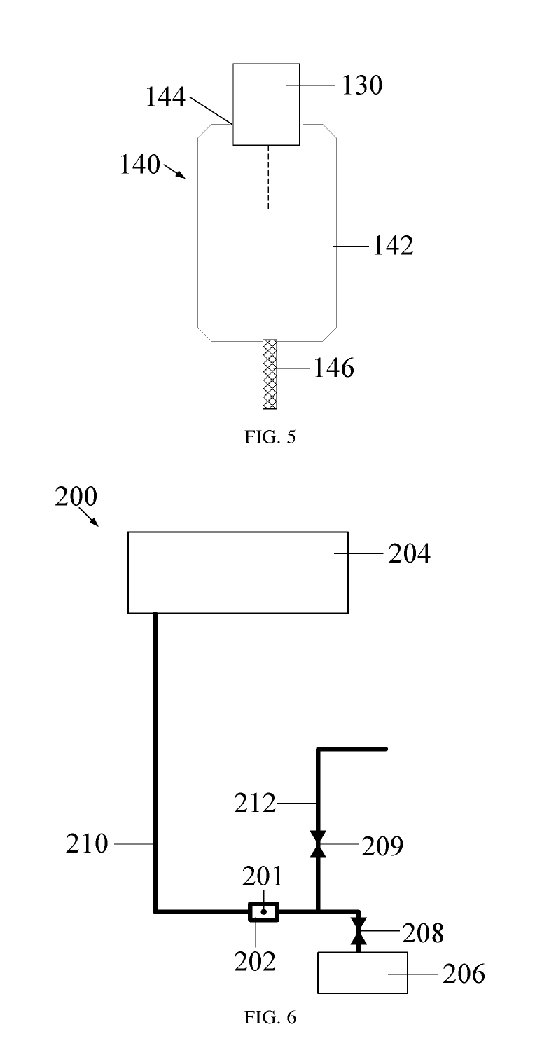

An embodiment of the present disclosure further provides a printing device, comprising the ink measuring system 100 provided by any embodiment of the present disclosure. The printing device can further comprise an ink recycling device 140 (as shown in FIG. 5).

FIG. 5 is a schematic diagram of an ink recycling device provided by an embodiment of the present disclosure. As shown in FIG. 5, the ink recycling device 140 includes a recycling cavity body 142 provided with a recycling hole 144. The ink recycling device 140 can effectively recycle ink, ink spattering is prevented and device pollution is reduced. For example, the size of the recycling hole 144 of the recycling cavity body 142 (for example, a minimal inner diameter of the recycling hole 144) is larger than a size of the sprayer 130 (for example, a maximal outer diameter of the sprayer 130), such that the sprayer 130 can conveniently enter the recycling cavity body 142. The ink recycling device 140 further includes an ink recycling pipeline 146, which penetrates through the recycling cavity body 142 and is used to recycle the ink. For example, the ink recycling pipeline 146 is disposed on a side opposite to the recycling hole 144.

For example, when the ink needs to be recycled, the sprayer 130 can enter the recycling cavity body 142 through the recycling hole 144 by using a moving device (for example, a lifting device), and then the sprayer 130 ejects ink. In this case, the ink can be collected away from the ink recycling pipeline 146 without spattering other devices except for the recycling cavity body 142, so as to prevent the ink from polluting other devices.

For example, the sprayer 130 can be driven by the moving device to be lifted or translated. When ink discharging is needed, the sprayer 130 is translated to a position above the ink recycling device 140 as shown in FIG. 5, and then the sprayer 130 enters the recycling cavity body 142 through the recycling hole 144 and discharges ink; and when an ink test is needed, the sprayer 130 is translated to the position of the ink measuring system 100 as shown in FIG. 2A or FIG. 2B, and an ink drop measurement is performed.

An ink-jet printing device has many pipelines, and bubbles are easily generated in a working process, which affects process stability. Before use, the ink can be subjected to bubble discharging preliminarily, and part of the bubbles can be eliminated. However, some bubbles are adsorbed together with molecules in the ink and cannot be separated out until temperature is changed, and these bubbles may affect stability of the printing process, and further affect product quality.

An embodiment of the present disclosure further provides a printing device, comprising a printing system having a bubble discharging function, which can effectively prevent process defects caused by the bubbles in a printing process.

For example, FIG. 6 is a first schematic diagram of a printing system having a bubble discharging function provided by an embodiment of the present disclosure. As shown in FIG. 6, an embodiment of the present disclosure further provides a printing system 200 having a bubble discharging function, which includes a liquid storage box 204; a sprayer 206; a liquid inlet pipeline 210 connected to the liquid storage box 204 and the sprayer 206; a bubble detecting device 202 disposed outside a bubble detecting point 201 of the liquid inlet pipeline 210; a sprayer valve 208 disposed in the liquid inlet pipeline 210, the sprayer valve 208 being located between the bubble detecting point 201 and the sprayer 206; a bubble discharging pipeline 212 connected with the liquid inlet pipeline 210, a connecting point between the bubble discharging pipeline 212 and the liquid inlet pipeline 210 being located between the bubble detecting point 201 and the sprayer valve 208; and a bubble discharging valve 209 disposed in the bubble discharging pipeline 212.

For example, the ink enters the liquid inlet pipeline 210 from the liquid storage box 204, and the bubble detecting device 202 detects bubbles from the outside of the bubble detecting point 201 in the liquid inlet pipeline 210. When the bubble detecting device 202 detects no bubbles, the sprayer valve 208 is opened, the bubble discharging valve 209 is closed, and the sprayer 206 operates normally; and when the bubble detecting device 202 detects bubbles, the sprayer valve 208 is closed, the bubble discharging valve 209 is opened, the sprayer 206 stops operation temporarily and the ink with bubbles is discharged from the bubble discharging pipeline 212.

In the printing system 200 having a bubble discharging function provided by embodiments of the present disclosure, the bubbles in the liquid inlet pipeline can be discharged, and the bubbles are prevented from entering the sprayer. Stability of the printing process is kept, and further the quality of a printed product is improved.

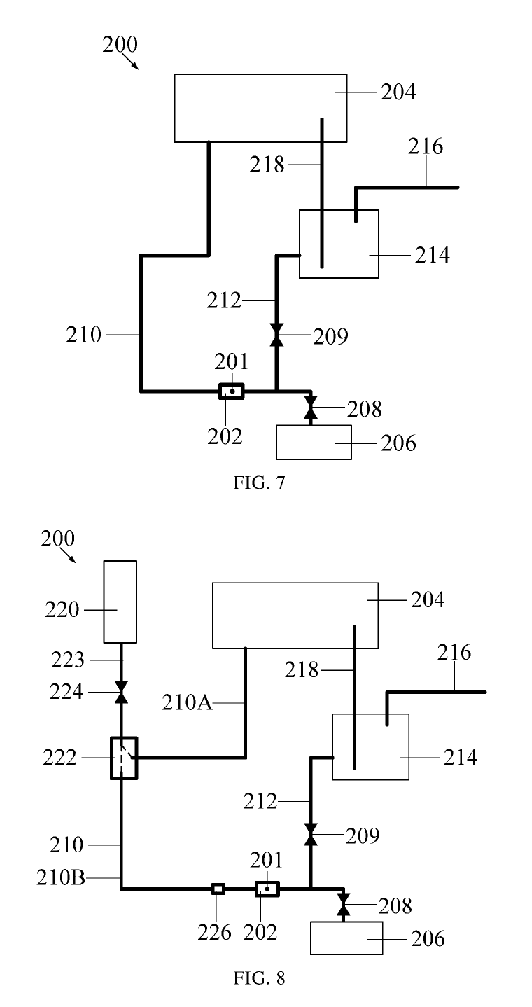

For example, FIG. 7 is a second schematic diagram of a printing system having a bubble discharging function provided by an embodiment of the present disclosure. As shown in FIG. 7, the printing system 200 provided by an embodiment of the present disclosure further includes an ink recycling box 214, an air path pipeline 216 and a recycling pipeline 218. The bubble discharging pipeline 212 is connected with the ink recycling box 214, a first end of the air path pipeline 216 is connected with the ink recycling box 214, a first end of the recycling pipeline 218 is connected with the ink recycling box 214, and a second end of the recycling pipeline 218 is connected with the liquid storage box 204.

For example, the printing system 200 further includes an air pressure adjusting device (not shown in FIG. 7) connected to the air path pipeline 216. The air pressure adjusting device can exhaust air from the ink recycling box 214 through the air path pipeline 216, such that a negative pressure state exists in the ink recycling box 214; the air pressure adjusting device can also inflate the ink recycling box 214 through the air path pipeline 216, such that a positive pressure state exists in the ink recycling box 214.

For example, the ink enters the liquid inlet pipeline 210 from the liquid storage box 204, and the bubble detecting device 202 detects whether bubbles exist from the outside of the bubble detecting point 201 in the liquid inlet pipeline 210. When the bubble detecting device 202 detects bubbles, the sprayer valve 208 is closed, the bubble discharging valve 209 is opened, the sprayer 206 temporarily stops operation, and the air pressure adjusting device exhausts air from the ink recycling box 214 through the air path pipeline 216, such that a negative pressure state exists in the ink recycling box 214 and the ink with bubbles flows into the ink recycling box 214 from the bubble discharging pipeline 212. When the bubble detecting device 202 detects no bubbles, the sprayer valve 208 is opened, the bubble discharging valve 209 is closed, the sprayer 206 operates normally, and the air pressure adjusting device inflates the ink recycling box 214 through the air path pipeline 216, such that a positive pressure state exists in the ink recycling box 214, and the ink in the ink recycling box enters the liquid storage box 204 through the recycling pipeline 218 after bubbles are discharged.

For example, in the printing system 200 provided by an embodiment of the present disclosure, a first end of the recycling pipeline 218 is disposed in a lower position in the ink recycling box, and a first end of the air path pipeline 216 is disposed in a higher position in the ink recycling box. For example, the position of the first end of the recycling pipeline 218 is lower than that of the first end of the air path pipeline 216. For example, a liquid level of the ink in the ink recycling box 214 is located between the first end of the recycling pipeline 218 and the first end of the air path pipeline 216. This configuration is adopted so that when the air pressure adjusting device exhausts air through the air path pipeline 216, the ink cannot be pumped out, and when the air pressure adjusting device inflates air to the ink recycling box 214 through the air path pipeline 216, air cannot enter the liquid storage box from the recycling pipeline 218.

The printing system 200 having a bubble removing function as shown in FIG. 7 can discharge the bubbles in the liquid inlet pipeline, the bubbles are prevented from entering the sprayer, the printing process is kept stable, and further the quality of a printed product is improved; meanwhile, the ink with bubbles can be recycled, such that the ink is saved, and cost is saved. Similar or identical components between the printing system as shown in FIG. 7 and the printing system as shown in FIG. 6 are not repeated herein.

For example, FIG. 8 is a third schematic diagram of a printing system having a bubble discharging function provided by an embodiment of the present disclosure. As shown in FIG. 8, the printing system 200 provided by an embodiment of the present disclosure further includes a temporary ink storage device 220, a liquid inlet valve 222 and a bubble pre-discharging pipeline 223. The liquid inlet valve 222 is disposed in the liquid inlet pipeline 210 and located between the bubble detecting point 201 and the liquid storage box 204, a first end of the bubble pre-discharging pipeline 223 is connected with the liquid inlet pipeline 210 through the liquid inlet valve 222, and a second end of the bubble pre-discharging pipeline 223 is connected with the temporary ink storage device 220.

In the printing system 200 provided by an embodiment of the present disclosure, the liquid inlet pipeline 210 includes a first liquid inlet sub-pipeline 210A and a second liquid inlet sub-pipeline 210B. The first liquid inlet sub-pipeline 210A is located between the liquid storage box 204 and the liquid inlet valve 222, and the second liquid inlet sub-pipeline 210B is located between the liquid inlet valve 222 and the sprayer 206. The liquid inlet valve 222 may be a multidirectional solenoid valve and is configured to connect the first end of the bubble pre-discharging pipeline 223 to the first liquid inlet sub-pipeline 210A or connect the first end of the bubble pre-discharging pipeline 223 to the second liquid inlet sub-pipeline 210B. The liquid inlet valve 222 can be other multidirectional valves, which is not limited by the present disclosure herein.

For example, the printing system 200 provided by an embodiment of the present disclosure further includes a temporary storage valve 224, and the temporary storage valve 224 is disposed in the bubble pre-discharging pipeline 223.

For example, in a working process of the printing system 200, the liquid inlet valve 222 connects the first end of the bubble pre-discharging pipeline 223 to the first liquid inlet sub-pipeline 210A. The temporary storage valve 224 is opened. The ink flows through the first liquid inlet sub-pipeline 210A from the liquid storage box 204, enters the bubble pre-discharging pipeline 223 via the liquid inlet valve 222, and then enters the temporary ink storage device 220 to be temporarily stored. The temporary storage valve 224 is closed, and a preliminary bubble discharging of the ink is carried out in the temporary storage process. After the preliminary bubble discharging is finished, the liquid inlet valve 222 connects the first end of the bubble pre-discharging pipeline 223 to the second liquid inlet sub-pipeline 210B. The temporary storage valve 224 is opened. The ink subjected to preliminary bubble discharging flows into the bubble pre-discharging pipeline 223 from the temporary ink storage device 220, then flows into the second liquid inlet sub-pipeline 210B via the liquid inlet valve 222 and then passes by the bubble detecting point 201. If the bubble detecting device 202 detects that the ink still has bubbles, the sprayer valve 208 is closed, the bubble-discharging valve 209 is opened, and the bubble-discharging processing is carried out again. If the ink has no bubbles, the ink enters the sprayer 206.

For example, when the temporary ink storage device 220 is not needed to be used, the liquid inlet valve 222 can be configured to connect the first liquid inlet sub-pipeline 210A to the second liquid inlet sub-pipeline 210B, and then, the printing system as shown in FIG. 8 and the printing system as shown in FIG. 7 have the same or similar functions.

For example, the printing system 200 provided by an embodiment of the present disclosure further includes a sprayer connector 226, and the sprayer connector 226 is disposed in the liquid inlet pipeline 210 between the bubble detecting point 201 and the liquid storage box 204. For example, the sprayer connector 226 is disposed in the liquid inlet pipeline 210 between the bubble detecting point 201 and the liquid inlet valve 222. For example, the sprayer connector 226 is used to detach and replace the sprayer 206. For example, a position where the sprayer connector 226 is disposed includes, but not limited to, the scenario as shown in FIG. 8 and the sprayer connector 226 can also be disposed in other positions in the pipeline.

In the printing system 200 having a bubble discharging function as shown in FIG. 8, the temporary ink storage device 220 and its supporting elements are added based on the printing system as shown in FIG. 7, preliminary bubble discharging of the ink is achieved, the bubbles are further prevented from entering the sprayer, a printing process is kept stable, and further the quality of a printed product is improved. The same description between the printing system as shown in FIG. 8 and the printing system as shown in FIG. 7 is not repeated here.

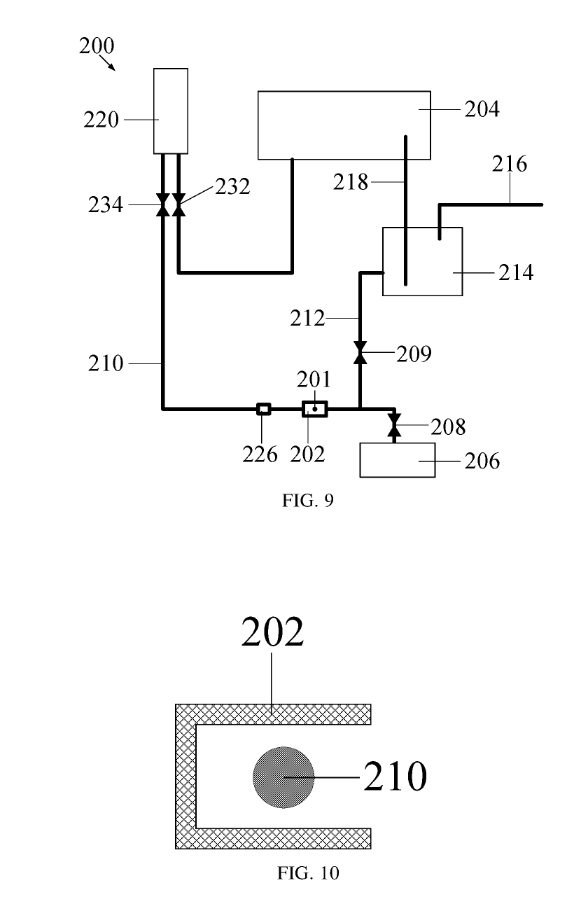

For example, FIG. 9 is a fourth schematic diagram of a printing system having a bubble discharging function provided by an embodiment of the present disclosure. Based on the printing system as shown in FIG. 7, as shown in FIG. 9 the printing system 200 provided by an embodiment of the present disclosure further includes an temporary ink storage device 220, a first temporary storage valve 232 and a second temporary storage valve 234. The temporary ink storage device 220 is disposed in the liquid inlet pipeline 210 and located between the bubble detecting point 201 and the liquid storage box 204, the first temporary storage valve 232 is disposed in the liquid inlet pipeline 210 and located between the temporary ink storage device 220 and the liquid storage box 204, and the second temporary storage valve 234 is disposed in the liquid inlet pipeline 210 and located between the temporary ink storage device 220 and the bubble detecting point 201.

For example, in a working process of the printing system 200, the first temporary storage valve 232 is opened, the second temporary storage valve 234 is closed, the ink flows through the liquid inlet pipeline 210 from the liquid storage box 204 and enters the temporary ink storage device 220 to be temporarily stored by the first temporary storage valve 232. In this case, the first temporary storage valve 232 is closed, and preliminary bubble discharging of the ink is carried out in the temporary storage process. After the preliminary bubble discharging is finished, the second temporary storage valve 234 is opened, the ink subjected to the preliminary bubble discharging flows into the liquid inlet pipeline 210 through the second temporary storage valve 234 from the temporary ink storage device 220, and then passes by the bubble detecting point 201. If the bubble detecting device 202 detects that the ink still has bubbles, the sprayer valve 208 is closed, the bubble discharging valve 209 is opened, and the bubble discharging processing is carried out again. If the ink has no bubbles, the ink enters the sprayer 206.

The difference between the printing system as shown in FIG. 9 and the printing system as shown in FIG. 8 includes no need to use a multidirectional solenoid valve. The printing system as shown in FIG. 9 achieves preliminary bubble discharging of the ink in addition to the technical effects of the printing system as shown in FIG. 7, the bubbles are further prevented from entering the sprayer, a printing process is kept stable, and further the quality of a printed product is improved. The same description between the printing system as shown in FIG. 9 and the printing system as shown in FIG. 8 is not repeated here.

For example, each valve in the printing system 200 having a bubble discharging function provided by embodiments of the present disclosure can be a solenoid valve or other valves used to control connection and disconnection of a pipeline.

For example, FIG. 10 is a schematic diagram of a bubble detecting device 202 in a printing system 200 having a bubble discharging function provided by an embodiment of the present disclosure. For example, the bubble detecting device 202 includes a sound wave bubble detecting device. The sound wave bubble detecting device can send sound waves to the ink to be detected and can receive and detect a corresponding echo signal. Since reflection coefficients of the air and ink for the sound waves are different, when the detected ink echo has noise, it is judged that there are bubbles in the ink. For example, the printing system having a sound wave bubble detecting device can improve the accuracy of bubble detection.

It is noted that the embodiments of the present disclosure include, but not limited to, the scenario where the bubble detecting device 202 is a sound wave bubble detecting device, and the bubble detecting device 202 can also be other types of bubble detecting devices such as a photoelectric bubble detecting device.

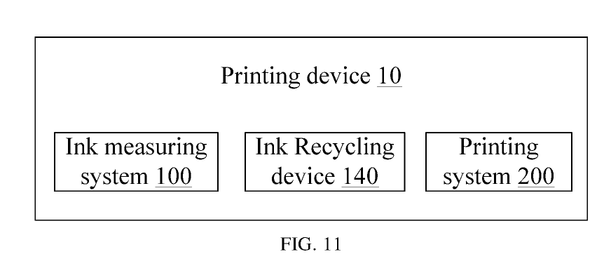

For example, FIG. 11 is a composition block diagram of a printing device provided by an embodiment of the present disclosure. The printing device can comprise a printing system provided by any embodiment of the present disclosure. For example, the printing device 10 can further comprise the ink measuring system 100 provided by any embodiment of the present disclosure. For example, the printing device 10 can further comprise the ink recycling device 140 provided by any embodiment of the present disclosure.

The printing device provided by embodiments of the present disclosure can be used to manufacture an OLED display device. It is noted that the embodiments of the present disclosure can be used in, but not limited to, manufacturing of the OLED display device and can also be used for other devices manufactured by using an ink-jet printing technology.

Although embodiments of the disclosure have been described above in details with general descriptions and specific embodiments, on the basis of the embodiment of the disclosure, various changes and improvements may be made, which is apparent to those skilled in the art. Therefore, all such changes and improvements without departing from the spirit of the disclosure are within the scope of the claims of the disclosure.

The present application claims the priority of the Chinese Patent Application No. 201610311363.6 filed on May 11, 2016, which is incorporated herein by reference in its entirety as part of the disclosure of the present application.

1. An ink measuring system, comprising:
a measuring cavity body provided with an opening, wherein the measuring cavity body includes a side wall and a bottom, and the bottom and the opening are oppositely disposed;
at least an air exhaust pipeline penetrating through the bottom; and
a filter core disposed inside the measuring cavity body.

2. The ink measuring system according to claim 1, wherein the filter core includes a honeycomb structure.

3. The ink measuring system according to claim 2, wherein the honeycomb structure is of a multilayered honeycomb structure.

4. The ink measuring system according to claim 2, wherein the honeycomb structure includes a plurality of honeycomb holes, and apertures of at least part of the honeycomb holes are smaller than 3 microns.

5. The ink measuring system according to claim 1, further comprising an air exhaust device, wherein the air exhaust device is disposed outside the measuring cavity body and is connected to the air exhaust pipeline.

6. The ink measuring system according to claim 1, further comprising a transparent structure, wherein the transparent structure is disposed on the side wall along the opening.

7. The ink measuring system according to claim 6, further comprising a measuring device, wherein the measuring device is disposed outside the transparent structure.

8. The ink measuring system according to claim 1, wherein the side wall and the bottom are hermetically sealed.

9. The ink measuring system according to claim 1, further comprising at least a cleaning pipeline, wherein the cleaning pipeline penetrates through the side wall of the measuring cavity body, and the cleaning pipeline is disposed between the filter core and the opening.

10. (canceled)

11. The ink measuring system according to claim 9, further comprising a cleaning device, wherein the cleaning device is disposed outside the measuring cavity body and is connected to the cleaning pipeline.

12. A printing device, comprising the ink measuring system according to claim 1.

13. The printing device according to claim 12, further comprising an ink recycling device, wherein the ink recycling device includes a recycling cavity body provided with a recycling hole and an ink recycling pipeline, and the ink recycling pipeline penetrates through the recycling cavity body.

14. (canceled)

15. The printing device according to claim 12, further comprising a printing system having a bubble discharging function, wherein the printing system includes:
a liquid storage box;
a sprayer;
a liquid inlet pipeline connected to the liquid storage box and the sprayer;
a bubble detecting device disposed outside a bubble detecting point of the liquid inlet pipeline;
a sprayer valve disposed in the liquid inlet pipeline, wherein the sprayer valve is located between the bubble detecting point and the sprayer;
a bubble discharging pipeline connected with the liquid inlet pipeline, wherein a connection point between the bubble discharging pipeline and the liquid inlet pipeline is located between the bubble detecting point and the sprayer valve; and
a bubble discharging valve disposed in the bubble discharging pipeline.

16. The printing device according to claim 15, wherein the printing system further includes an ink recycling box, an air path pipeline and a recycling pipeline, the bubble discharging pipeline is connected with the ink recycling box, a first end of the air path pipeline is connected with the ink recycling box, a first end of the recycling pipeline is connected with the ink recycling box, and a second end of the recycling pipeline is connected with the liquid storage box; and
wherein in the ink recycling box, a position of the first end of the recycling pipeline is lower than a position of the first end of the air path pipeline.

17. (canceled)

18. The printing device according to claim 15, wherein the printing system further includes an temporary ink storage device, a liquid inlet valve and a bubble pre-discharging pipeline, the liquid inlet valve is disposed in the liquid inlet pipeline and located between the bubble detecting point and the liquid storage box, a first end of the bubble pre-discharging pipeline is connected with the liquid inlet pipeline via the liquid inlet valve, and a second end of the bubble pre-discharging pipeline is connected with the temporary ink storage device.

19. The printing device according to claim 18, wherein the liquid inlet pipeline includes a first liquid inlet sub-pipeline and a second liquid inlet sub-pipeline, the first liquid inlet sub-pipeline is located between the liquid storage box and the liquid inlet valve, and the second liquid inlet sub-pipeline is located between the liquid inlet valve and the sprayer; the liquid inlet valve is a multidirectional solenoid valve and is configured to connect the first end of the bubble pre-discharging pipeline to the first liquid inlet sub-pipeline or connect the first end of the bubble pre-discharging pipeline to the second liquid inlet sub-pipeline.

20. The printing device according to claim 18, wherein the printing system further includes a temporary storage valve, and the temporary storage valve is disposed in the bubble pre-discharging pipeline.

21. The printing device according to claim 15, wherein the printing system further includes an temporary ink storage device, a first temporary storage valve and a second temporary storage valve, the temporary ink storage device is disposed in the liquid inlet pipeline and located between the bubble detecting point and the liquid storage box, the first temporary storage valve is disposed in the liquid inlet pipeline and located between the temporary ink storage device and the liquid storage box, and the second temporary storage valve is disposed in the liquid inlet pipeline and located between the temporary ink storage device and the bubble detecting point.

22. The printing device according to claim 15, wherein the printing system further includes a sprayer connector, and the sprayer connector is disposed in the liquid inlet pipeline between the bubble detecting point and the liquid storage box.

23. The printing device according to claim 15, wherein the bubble detecting device includes a sound wave bubble detecting device.
